(19) United States
(12) Patent Application Publication
(10) Pub. No.: US 2007/0241848 A1
(43) Pub. Date: Oct. 18, 2007

(54) Magnetic element

(75) Inventor: Kan Sano, Tokyo (JP)

Correspondence Address: DEXTER L. MCFARLIN;MASSEY, STOTSER, AND NICHOLS, P.C., P.O. BOX 94308, BIRMINGHAM, AL, 35220, US

(73) Assignee: Sumida Corporation

(21) Appl. No.: 11/786,876

(22) Filed: Apr. 13, 2007

(30) Foreign Application Priority Data
Apr. 14, 2006 (JP) JP2006-111816

(51) Int. Cl. H01H 1/00

(52) U.S. Cl. 335/213

(57) ABSTRACT

According to an aspect of the invention, a low profile can be achieved while the number of turns of the winding wire is secured. The magnetic element includes a rectangular-solid magnetic member and a conductor. A bellows-like metal flat plate snakes along a longitudinal direction in the conductor. In the bellows-like metal flat plate, snaking portions located in a direction perpendicular to the longitudinal direction are mutually projected toward opposite directions to form a space into which the magnetic member is inserted.

### CLAIM OF PRIORITY

This application claims the benefit of Japanese Patent Application No. 2006-111816 filed on Apr. 14, 2006, the entire contents of which are hereby incorporated by reference herein.

### BACKGROUND OF THE INVENTION

1. Field of the Invention

The present invention relates to a magnetic element used in various electric instruments such as a portable telephone, a personal computer, and a television.

2. Description of the Related Art

Conventionally, there is known a magnetic element having a configuration in which a winding wire is wound about a drum-shape core. For example, Japanese Patent Laid-Open No. 2004-79917 discloses this kind of magnetic element.

In the magnetic element disclosed in Japanese Patent Laid-Open No. 2004-79917, a magnet wire is wound about a circular cylindrical portion of the drum-shape core, and a sleeve core having a ring shape is arranged outside the drum-shape core so as to coaxially surround the drum-shape core. The drum-shape core has flanges at top and bottom ends of the circular cylindrical portion.

However, the magnetic element disclosed in Japanese Patent Laid-Open No. 2004-79917 is one in which the drum-shape core is used. Generally, in the magnetic element in which the drum-shape core is used, for the view point of strength on a structure, it is necessary that a thickness of each flange be set to about 0.25 mm at the minimum. In consideration of cutting and the like in a production process, it is necessary that a height of the circular cylindrical portion be set to about 0.4 mm. Therefore, a dimension becomes 0.9 mm at the minimum in a height direction of the magnetic element in which the drum-shape core is used. Accordingly, there is a limitation to achievement of a low profile in the magnetic element in which the drum-shape core is used.

In view of the foregoing, an object of the invention is to provide a magnetic element in which the low profile can be achieved while the number of turns of the winding wire is secured.

### SUMMARY OF THE INVENTION

A magnetic element according to a first aspect of the invention includes a rectangular-solid magnetic member; and a conductor in which, in a bellows-like metal flat plate snaking along a longitudinal direction, snaking portions located in a direction perpendicular to the longitudinal direction are mutually projected toward opposite directions to form a space into which the magnetic member is inserted.

According to the magnetic element according to the first aspect of the invention, in the conductor, the snaking portions are arranged outside the magnetic member so as to face the magnetic member. Because the dimension in the height direction of the magnetic element becomes the sum of the thickness of the magnetic member and the thicknesses of the conductors located both sides of the magnetic member, the low profile is easily achieved in the magnetic element. Furthermore, because the magnetic member has the rectangular-solid shape, unlike the conventional drum-shape core, it is not necessary that the magnetic member be designed in consideration of securing of the winding frame and the strength of the flange. Accordingly, the dimension can easily be decreased in the height direction of the magnetic member, which allows the low profile to be achieved in the magnetic element.

A magnetic element according to a second aspect of the invention includes a rectangular-solid magnetic member; and a conductor in which, in a bellows-like metal flat plate snaking along a longitudinal direction, snaking portions located in a direction perpendicular to the longitudinal direction are mutually projected toward only one direction to form a space into which the magnetic member is inserted.

According to the magnetic element according to the second aspect of the invention, in the conductor, the snaking portions are arranged outside the magnetic member so as to face the magnetic member. Because the dimension in the height direction of the magnetic element becomes the sum of the thickness of the magnetic member and the thicknesses of the conductors located both sides of the magnetic member, the low profile is easily achieved in the magnetic element. Furthermore, because the magnetic member has the rectangular-solid shape, unlike the conventional drum-shape core, it is not necessary that the magnetic member be designed in consideration of securing of the winding frame and the strength of the flange. Accordingly, the dimension can easily be decreased in the height direction of the magnetic member, which allows the low profile to be achieved in the magnetic element.

A magnetic element according to a third aspect of the invention includes a conductor in which, in a bellows-like metal flat plate snaking along a longitudinal direction, snaking portions located in a direction perpendicular to the longitudinal direction are mutually projected toward opposite directions to form a space; and a compressed powder body which is arranged at least inside the conductor, the compressed powder body being made of magnetic powders.

According to the magnetic element according to the third aspect of the invention, in the case where the compressed powder body is arranged inside the conductor, in the conductor, the snaking portions are arranged outside the magnetic member so as to face the compressed powder body. Because the dimension in the height direction of the magnetic element becomes the sum of the thickness of the magnetic member and the thicknesses of the conductors located both sides of the magnetic member, the low profile is easily achieved in the magnetic element. Furthermore, in the case where the compressed powder body is arranged not only inside the conductor but also outside the conductor, because the thickness of the compressed powder body arranged outside the conductor becomes the dimension in the height direction of the magnetic element, unlike the conventional magnetic element in which the drum-shape core is used, it is not necessary that the core be designed in consideration of securing of the winding frame and the strength of the flange. Accordingly, the low profile can be achieved in the magnetic element.

In the magnetic element according to the first to third aspect of the invention, preferably a ring core having a frame shape is arranged to surround an outside of the magnetic element. Therefore, magnetic fluxes generated by the conductor enter the inside of the ring core after passing through the inside of the magnetic member. Then, the magnetic fluxes pass through the inside of the ring core to enter the inside of the magnetic member again. Accordingly, a closed magnetic path is formed between the magnetic member and the ring core, so that the magnetic flux can be prevented from leaking to the outside of the magnetic element. As a result, the generation of a noise or an eddy current can be prevented in various electric instruments equipped with the magnetic element.

According to the invention, the low profile can be achieved while the number of turns of the winding wire is secured.

### BRIEF DESCRIPTION OF THE DRAWINGS

FIG. 1 is a perspective view showing a configuration of a magnetic element according to a first embodiment of the invention;

FIG. 2 is a plan view showing the magnetic element according to a first embodiment of the invention;

FIG. 3 is a front view showing the magnetic element according to a first embodiment of the invention;

FIG. 4 is a perspective view showing a configuration of a conductor in FIG. 1;

FIG. 5 is a plan view showing the conductor in FIG. 1;

FIG. 6 is a front view showing a coil in FIG. 1;

FIG. 7 is a plan view showing a magnetic element according to a second embodiment of the invention;

FIG. 8 is a front view showing the magnetic element according to a second embodiment of the invention;

FIG. 9 is a plan view showing a magnetic element according to a third embodiment of the invention; and

FIG. 10 is a view showing a modification of the invention.

### DESCRIPTION OF THE PREFERRED EMBODIMENTS

### First Embodiment

A magnetic element 10 according to a first embodiment of the invention will be described below with reference to the drawings.

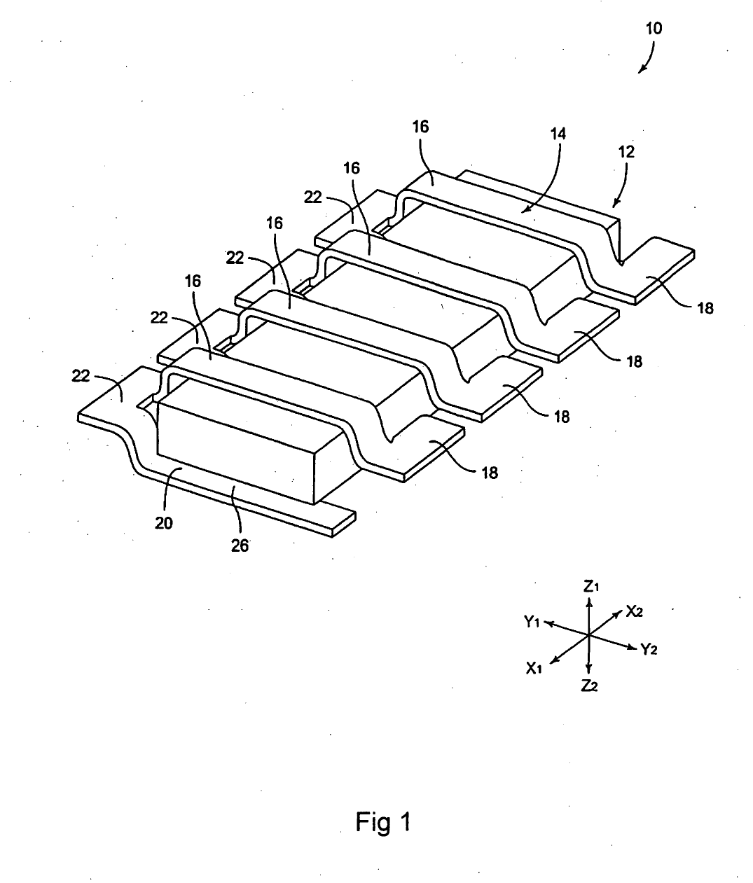

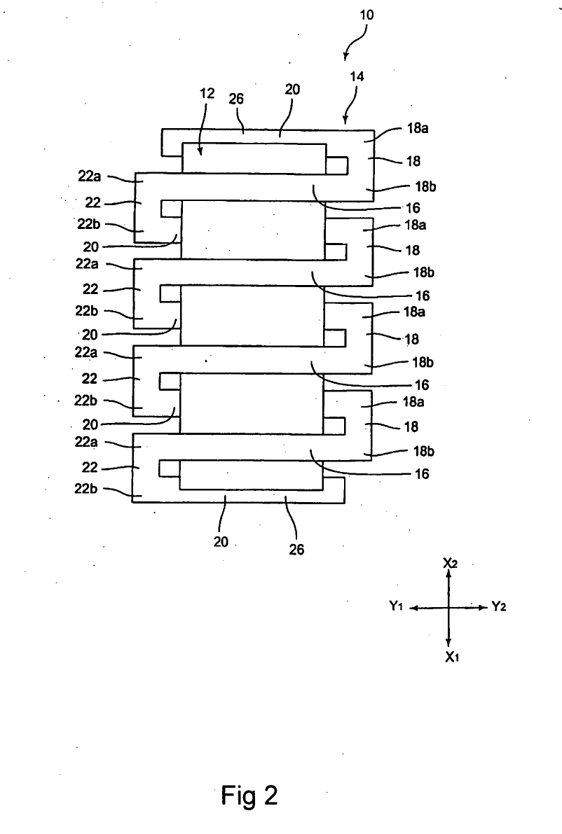

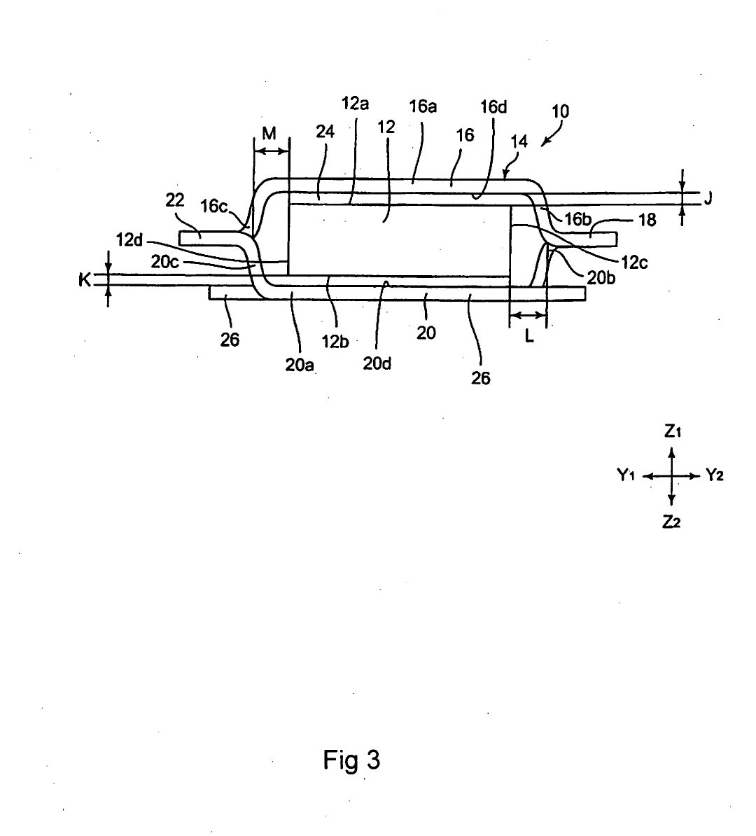

FIG. 1 is a perspective view showing a configuration of the magnetic element 10 of the first embodiment. FIG. 2 is a plan view showing the magnetic element 10 of the first embodiment. FIG. 3 is a front view showing the magnetic element 10 of the first embodiment. In the following description, it is assumed that a front side is indicated by a direction of an arrow X₁ shown in FIGS. 1 to 9, a rear side is indicated by a direction of an arrow X₂, a left side is indicated by a direction of an arrow Y₁, a right side is indicated by a direction of an arrow Y₂, upper side is indicated by a direction of an arrow Z₁, and lower side is indicated by a direction of an arrow Z₂.

As shown in FIGS. 1 to 3, the magnetic element 10 is a surface mounted type magnetic element, and the magnetic element 10 mainly includes a rectangular-solid magnetic member 12 and a spiral coil 14. The magnetic member 12 is arranged inside the coil 14.

The magnetic member 12 is made of a magnetic material such as ferrite. However, other magnetic materials such as permalloy, sendust, iron, and carbonyl may be used as the material of the magnetic member 12.

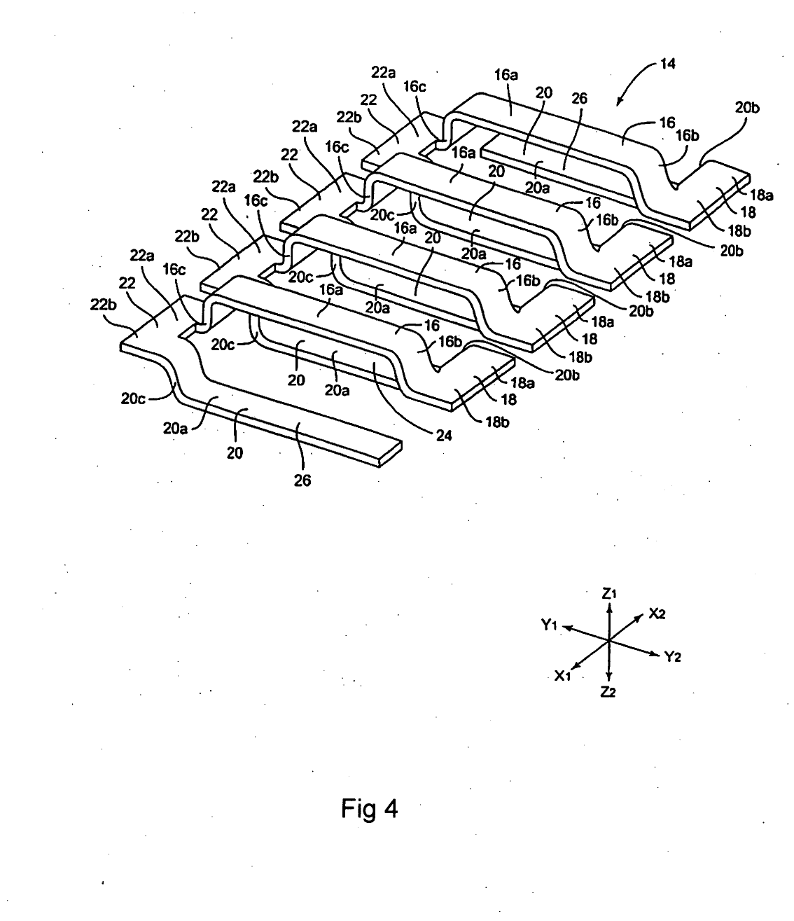

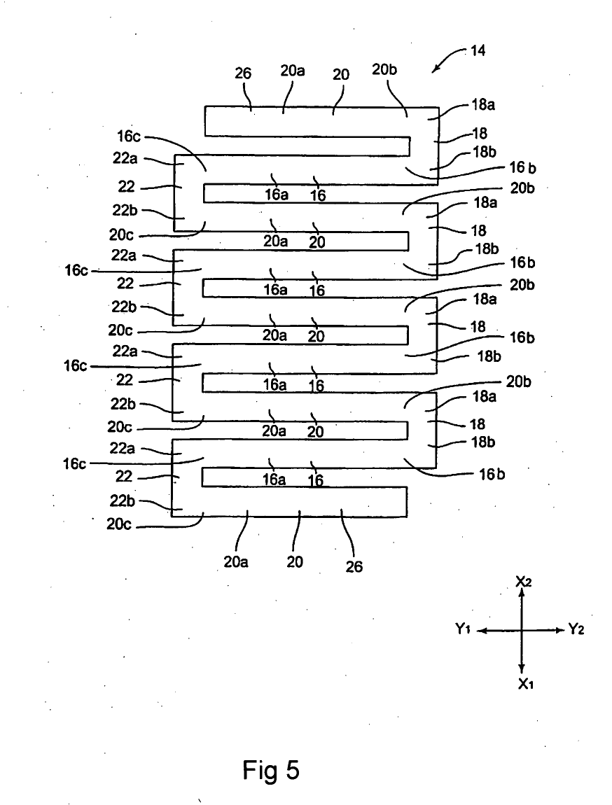

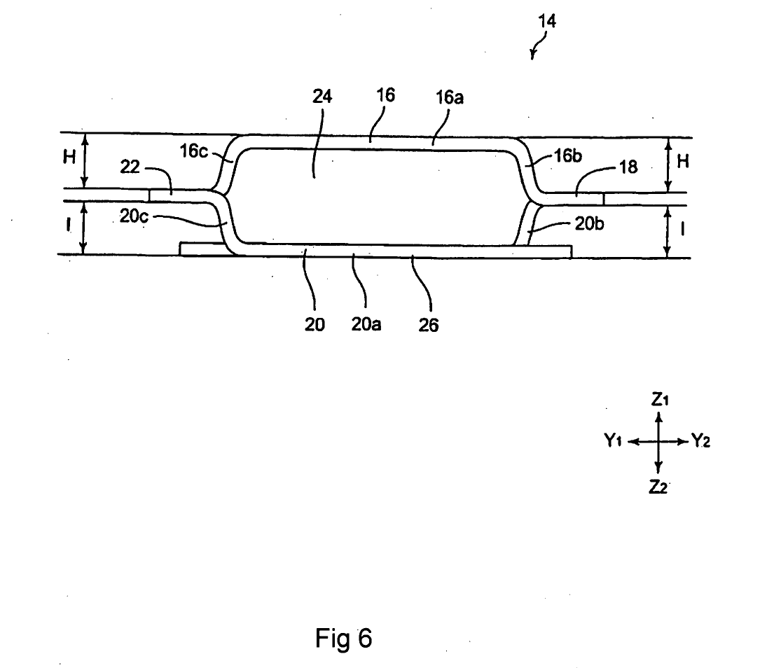

FIG. 4 is a perspective view showing a configuration of the coil 14. FIG. 5 is a plan view of the coil 14. FIG. 6 is a front view of the coil 14.

As shown in FIG. 5, when the coil 14 is viewed from above, the coil 14 is wound in a longitudinal direction while snaking along the longitudinal direction. Preferably the coil 14 is made of a metal such as copper having excellent conductivity, although the coil 14 may be made of a metal such as stainless steel, iron, and aluminum.

As shown in FIGS. 4 and 5, the coil 14 has an upper extended portion 16, a right side portion 18, a lower extended portion 20, and a left side portion 22. The upper extended portion 16 is extended in a crosswise direction perpendicular to the longitudinal direction of the coil 14. The right side portion 18 located on the right side is extended in the longitudinal direction of the coil 14. The lower extended portion 20 is extended in the crosswise direction. The left side portion 22 located on the left side is extended in the longitudinal direction. The upper extended portion 16 is extended from a rear end portion 22a of the left side portion 22 toward the substantially crosswise direction. The right side portion 18 is extended from a front end of the upper extended portion 16 toward the substantially longitudinal direction. The lower extended portion 20 is extended from a rear end portion 18a of the right side portion 18 toward the substantially crosswise direction. The left side portion 22 is extended from a front end of the lower extended portion 20 toward the substantially longitudinal direction. Thus, the coil 14 is wound such that the upper extended portion 16, the right side portion 18, the lower extended portion 20, and the left side portion 22 are continuously connected.

Both the right side portion 18 and the left side portion 22 are formed in a flat shape along the longitudinal direction of the coil 14. The right side portion 18 and the left side portion 22 are located on the right side and left side of the coil 14 respectively. As shown in FIG. 6, the right side portion 18 and the left side portion. 22 are located on the same plane. The right side portion 18 is horizontally projected toward the right side of the coil 14. The left side portion 22 is horizontally projected toward the left side of the coil 14.

As shown in FIGS. 4 and 6, the upper extended portion 16 includes an upper flat plate portion 16a, a lower right curved portion 16b, and a lower left curved portion 16c. The upper flat plate portion 16a formed in flat shape is extended in the crosswise direction of the coil 14. The lower right curved portion 16b is extended while curved downward from a right end of the upper flat plate portion 16a. The lower left curved portion 16c is extended while curved downward from a left end of the upper flat plate portion 16a. The front end of the lower right curved portion 16b is connected to a front end portion 18b of the right side portion 18, and the front end of the lower left curved portion 16c is connected to the rear end portion 22a of the left side portion 22.

The lower extended portion 20 includes a lower flat plate portion 20a, an upper right curved portion 20b, and an upper left curved portion 20c. The lower flat plate portion 20a formed in flat shape is extended in the crosswise direction of the coil 14. The upper right curved portion 20b is extended while curved upward from the right end of the lower flat plate portion 20a. The upper left curved portion 20c is extended while curved upward from the left end of the lower flat plate portion 20a. The front end of the upper right curved portion 20b is connected to the rear end portion 18a of the right side portion 18, and the front end of the upper left curved portion 20c is connected to a front end portion 22b of the left side portion 22.

Dimensions in height directions of the lower right curved portion 16b and lower left curved portion 16c are equal to dimensions in height directions of the upper right curved portion 20b and upper left curved portion 20c respectively. That is, as shown in FIG. 6, a height H from the right side portion 18 is equal to a height H from the left side portion 22 of the upper flat plate portion 16a. Similarly, a height I from the right side portion 18 is equal to a height I from the left side portion 22 of the lower flat plate portion 20a. Therefore, the coil 14 is formed in the spiral shape by the upper extended portions 16 and the lower extended portions 20 through the right side portions 18 and the left side portions 22, which allows an air-core portion 24 to be formed inside the coil 14. The air-core portion 24 is inserted into the coil 14 in the longitudinal direction. In the first embodiment, the lower extended portion 20 located at the front end in the coil 14 and the lower extended portion 20 located at the rear end in the coil 14 become terminal ends 26 of the coil 14. The coil 14 is formed by vertically pressing and/or forming a bellows-like metal plate which is extended in the longitudinal direction while snaking along the longitudinal direction in the same plane. For example, terminal portions of the coil 14 can be formed by the pressing and/or forming. In the first embodiment, the terminal ends 26 and 26 correspond to the terminal portions. In the case where the magnetic element 10 is mounted on a circuit board, because the lower side of the magnetic element 10 is bonded on the circuit board, the terminal ends 26 and 26 are electrically connected to the circuit board.

As shown in FIGS. 1 and 3, the magnetic member 12 is arranged in the substantial center of the air-core portion 24 in the coil 14. In this state of things, as shown in FIGS. 1 and 2, the conductor constituting the coil 14 is wound in the substantially spiral shape about the magnetic member 12. As shown in FIG. 3, an upper surface 12a of the magnetic member 12 faces an inside surface 16d of the upper flat plate portion 16a. A space J is formed between the upper surface 12a and the inside surface 16d. A lower surface 12b of the magnetic member 12 faces an inside surface 20d of the lower flat plate portion 20a. A space K is formed between the lower surface 12b and the inside surface 20d. A space L is formed between the right side portion 18 and the right side face 12c of the magnetic member 12, and a space M is formed between the left side face 12d and the left side portion 22. However, preferably the spaces J, K, L, and M are provided as narrow as possible between the magnetic member 12 and the coil 14. Only a part of the spaces J, K, L, and M may be provided while remaining spaces are not provided. The magnetic element 10 is mounted on the circuit board with the side of the lower extended portion 20 down.

In the magnetic element 10 having the above configuration, the magnetic member 12 is arranged in the air-core portion 24 of the coil 14 having the spiral shape. Therefore, the upper extended portion 16 and the lower extended portion 20 are arranged in the vertical outside of the magnetic member 12 such that wide surfaces of the upper extended portion 16 and lower extended portion 20 face the magnetic member 12. Accordingly, the dimension in the height direction of the magnetic element 10 becomes a distance from the upper flat plate portion 16a to the lower flat plate portion 20a, so that the low profile can be achieved in the magnetic element 10. Furthermore, because the magnetic member 12 has the rectangular-solid shape, unlike the conventional drum-shape core, it is not necessary that the magnetic member 12 be designed in consideration of securing of the winding frame and the strength of the flange. Accordingly, the dimension can easily be decreased in the height direction of the magnetic member 12, which allows the low profile to be achieved in the magnetic element 10.

### Second Embodiment

A magnetic element 30 according to a second embodiment of the invention will be described below with reference to the drawings. In the magnetic element 30 of the second embodiment, the same component as that of the first embodiment is designated by the same numeral, and the description is neglected or simplified.

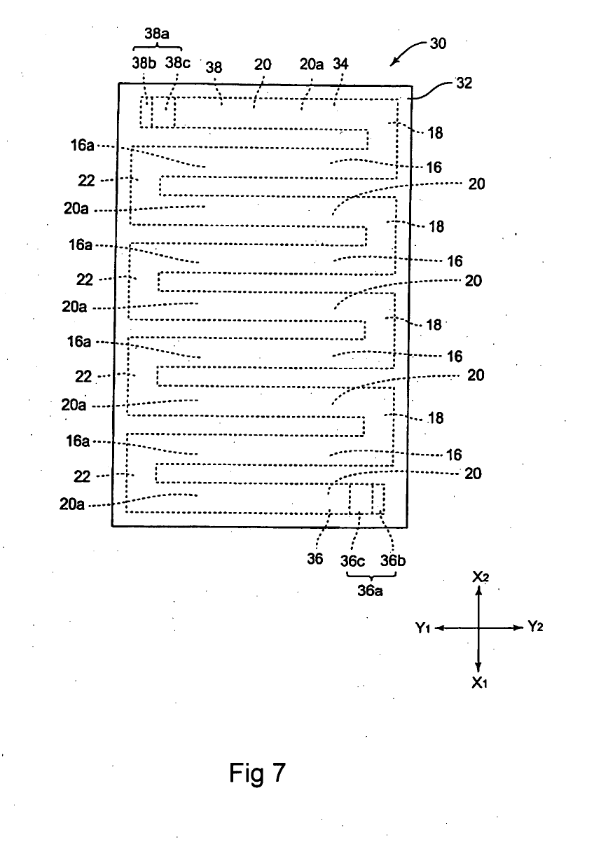

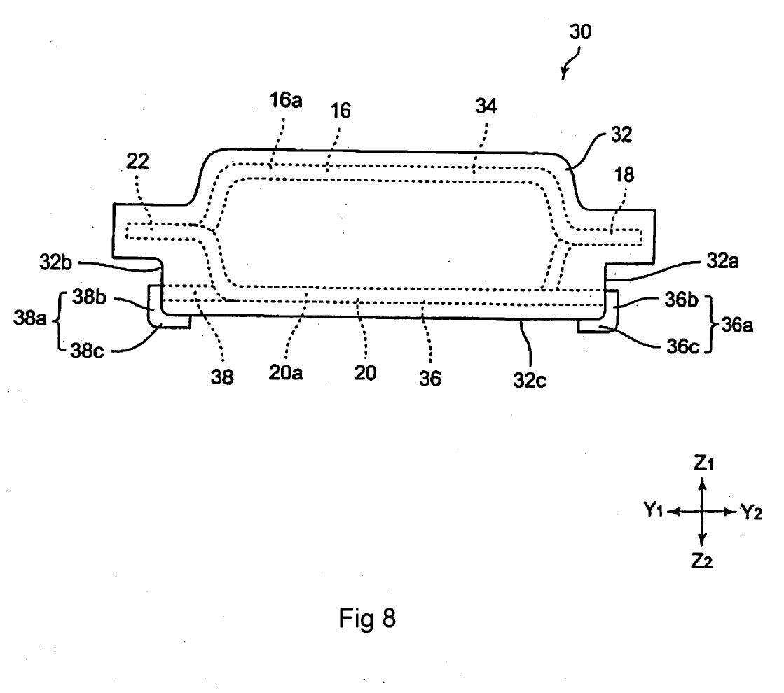

FIG. 7 is a plan view showing the magnetic element 30 of the second embodiment. FIG. 8 is a front view showing the magnetic element 30 of the second embodiment.

As shown in FIGS. 7 and 8, the magnetic element 30 mainly includes a compressed powder body 32 and a coil 34. The compressed powder body 32 is formed by compressing magnetic powders.

The coil 34 has the substantially same configuration as the coil 14 of the first embodiment. The coil 34 differs from the coil 14 in that an outside electrode 36a and an outside electrode 38a are formed at terminal ends 36 and 38 corresponding to the terminal ends 26 and 26 of the first embodiment respectively. As shown in FIG. 8, the outside electrode 36a has a side electrode portion 36b and a bottom electrode portion 36c. The side electrode portion 36b is extended downward from the front end of the terminal end 36, and the bottom electrode portion 36c is extended toward the leftward direction from the front end of the side electrode portion 36b. The outside electrode 38a has a side electrode portion 38b and a bottom electrode portion 38c. The side electrode portion 38b is extended downward from the front end of the terminal end 38, and the bottom electrode portion 38c is extended toward the rightward direction from the front end of the side electrode portion 38b. Preferably the coil 34 is made of a metal such as copper having excellent conductivity, although the coil 34 may be made of a metal such as stainless steel, iron, and aluminum.

As shown in FIGS. 7 and 8, except the outside electrodes 36a and 38a, the outside of the coil 34 is covered with the compressed powder body 32. That is, the outside electrodes 36a and 38a are exposed to the outside of the compressed powder body 32. As shown in FIG. 8, the side electrode portion 36b is formed on the right side of the right side face 32a so as to be brought into contact with the right side face 32a of the compressed powder body 32. The side electrode portion 38b is formed on the left side of the left side face 32b so as to be brought into contact with the left side face 32b of the compressed powder body 32. The bottom electrode portions 36c and 38c are formed beneath the bottom surface 32c so as to be brought into contact with the bottom surface 32c of the compressed powder body 32. Therefore, when the magnetic element 30 is mounted on the circuit board, each of the bottom electrode portions 36c and 38c is electrically connected to the circuit board.

The coil 34 is embedded in the magnetic powder constituting the compressed powder body 32, and heat and pressure applied from the outside, which forms the magnetic element 30. Pressure forming can be cited as an example of the method of applying the heat and pressure, although the method is not limited to the pressure forming. Metal magnetic powders mainly containing soft-magnetic ferrite or iron powder can be cited as an example of the magnetic powder, although the magnetic powder is not limited to the soft-magnetic ferrite or iron powder.

In the magnetic element 30 having the above configuration, the coil 34 is wound such that the wide surface of the coil 34 faces the inside. Therefore, the dimension can be decreased in the height direction of the coil 34. Furthermore, because the compressed powder body 32 is arranged such that the outside of the coil 34 is covered with the compressed powder body 32, unlike the conventional drum-shape core, it is not necessary that the design be performed in consideration of securing of the winding frame and the strength of the flange. Accordingly, the dimension can easily be decreased in the height direction of the compressed powder body 32, which allows the low profile to be achieved in the magnetic element 30.

### Third Embodiment

A magnetic element 40 according to a third embodiment of the invention will be described below with reference to the drawing. In the magnetic element 40 of the third embodiment, the same component as that of the first embodiment is designated by the same numeral, and the description is neglected or simplified.

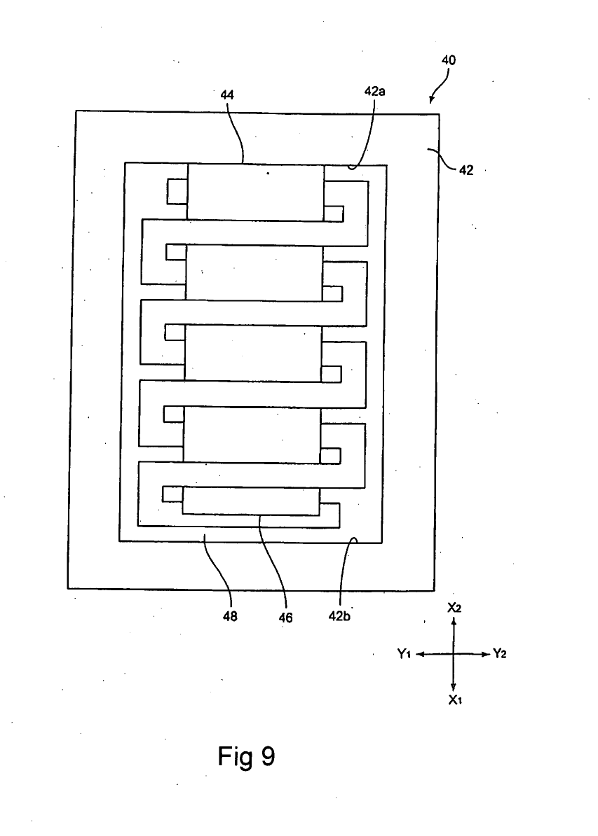

FIG. 9 is a plan view showing the magnetic element 40 of the third embodiment.

In the magnetic element 40, a ring core 42 having a substantially square frame shape is arranged outside the magnetic element 10 of the first embodiment. A rear end face 44 of the magnetic member 12 abuts on an inside rear surface 42a of the ring core 42. The inside rear surface 42a is located inside the ring core 42 and on the rear side of the ring core 42. The rear end face 44 and the inside rear surface 42a are fixed to each other with a bonding agent. A gap 48 is formed between a front end face 46 of the magnetic member 12 and an inside front surface 42b of the ring core 42. The inside front surface 42b is located inside the ring core 42 and on the front side of the ring core 42. Preferably, as with the magnetic member 12, the ring core 42 is made of a magnetic material such as ferrite. However, other magnetic materials such as permalloy, sendust, iron, and carbonyl may be used as the ring core 42.

In the magnetic element 40 having the above configuration, the ring core 42 is arranged so as to surround the outside of the magnetic element 40. Therefore, magnetic fluxes generated by the coil 14 enter the inside of the ring core 42 after passing through the inside of the magnetic member 12. Then, the magnetic fluxes pass through the inside of the ring core 42 to enter the inside of the magnetic member 12 again. Because the closed magnetic path is formed between the magnetic member 12 and the ring core 42, the magnetic flux can be prevented from leaking to the outside of the magnetic element 40. As a result, the generation of the noise or the eddy current can be prevented in various electric instruments equipped with the magnetic element 40.

In the magnetic element 40, the gap 48 is provided between the front end face 46 of the magnetic member 12 and the inside front surface 42b of the ring core 42, which allows permeability to be decreased between the magnetic member 12 and the ring core 42. Accordingly, saturation of magnetization can be prevented in the magnetic element 40.

Although the embodiments of the invention are described above, the invention is not limited to the above embodiments, and various modifications can be made.

In the above embodiments, the upper extended portion 16 and the lower extended portion 20 are extended toward the substantially crosswise directions of the coils 14 and 34 respectively. Alternatively, both or one of the upper extended portion 16 and the lower extended portion 20 may be obliquely extended with respect to the crosswise directions of the coils 14 and 34. In the above embodiments, the right side portion 18 and the left side portion 22 are extended toward the substantially longitudinal directions of the coils 14 and 34 respectively. Alternatively, both or one of the right side portion 18 and the left side portion 22 may be obliquely extended with respect to the longitudinal directions of the coils 14 and 34.

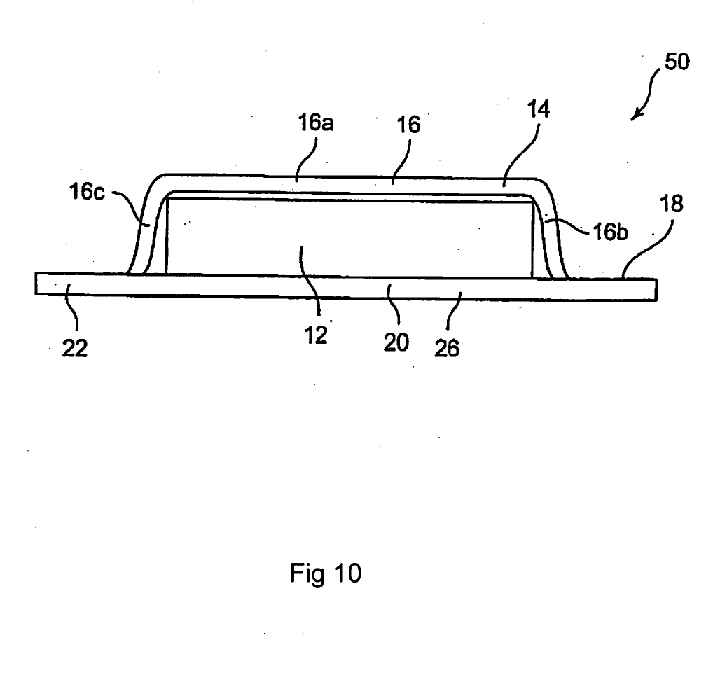

In the above embodiments, the upper extended portion 16 is formed above the right side portion 18 and the left side portion 22, and the lower extended portion 20 is formed below the right side portion 18 and the left side portion 22. Alternatively, as shown in FIG. 10, a magnetic element 50 may be formed such that the lower extended portion 20 constitutes the same plane along with the right side portion 18 and the left side portion 22.

In the above embodiments, in the coils 14 and 34, the heights H from the right side portion 18 and the left side portion 22 to the upper flat plate portion 16a are equal to each other, and the heights I from the right side portion 18 and the left side portion 22 to the lower flat plate portion 20a are equal to each other. However, the invention is not limited to the embodiment. The height H from the right side portion 18 to the upper flat plate portion 16a may differ from the height H from the left side portion 22 to the upper flat plate portion 16a, and the height I from the right side portion 18 to the lower flat plate portion 20.a may differ from the heights I from the left side portion 22 to the lower flat plate portion 20a.

In the second embodiment, the compressed powder body 32 is arranged such that the outside of the coil 34 is covered with the compressed powder body 32. However, the invention is not limited to the second embodiment, but the compressed powder body 32 may be arranged only inside the coil 34.

In the second embodiment, the outside electrodes 36a and 38a are formed while being integral with the terminal ends 36 and 38 respectively. However, the invention is not limited to the second embodiment, but the outside electrodes 36a and 38a may be formed independently of the terminal ends 36 and 38 respectively.

In the first or third embodiment, the magnetic member 12 is arranged in the substantial center of the air-core portion 24 of the coil 14. However, it is not necessary to particularly specify the position where the magnetic member 12 is arranged in the air-core portion 24. For example, the magnetic member 12 may be arranged in the air-core portion 24 such that the lower surface 12b of the magnetic member 12 is brought into contact with the inside surface 20d of the coil 14.

In the third embodiment, the rear end face 44 of the magnetic member 12 abuts on the inside rear surface 42a of the ring core 42. For example, the rear end face 44 may be configured so as not to abut on the inside rear surface 42a, and a gap is provided between the rear end face 44 and the inside rear surface 42a. The front end face 46 may also be configured so as to abut on the inside front surface 42b while the rear end face 44 abuts on the inside rear surface 42a.

In the third embodiment, the ring core 42 has the substantially square frame shape. However, the invention is not limited to the square frame shape, but the ring core 42 may have other frame shapes such as an elliptical frame shape and a circular frame shape.

The magnetic element of the invention can be applied to electric instruments such as a portable telephone, a personal computer, and a television.

What is claimed is:

1. A magnetic element comprising:
a rectangular-solid magnetic member; and
a conductor in which, in a bellows-like metal flat plate snaking along a longitudinal direction, snaking portions located in a direction perpendicular to the longitudinal direction are mutually projected toward opposite directions to form a space into which the magnetic member is inserted.

2. A magnetic element comprising:
a rectangular-solid magnetic member; and
a conductor in which, in a bellows-like metal flat plate snaking along a longitudinal direction, snaking portions located in a direction perpendicular to the longitudinal direction are mutually projected toward only one direction to form a space into which the magnetic member is inserted.

3. A magnetic element comprising:
a conductor in which, in a bellows-like metal flat plate snaking along a longitudinal direction, snaking portions located in a direction perpendicular to the longitudinal direction are mutually projected toward opposite directions to form a space; and
a compressed powder body which is arranged at least inside the conductor, the compressed powder body being made of magnetic powders.

4. The magnetic element according to claim 1, wherein a ring core having a frame shape is arranged to surround an outside of the magnetic element.

5. The magnetic element according to claim 2, wherein a ring core having a frame shape is arranged to surround an outside of the magnetic element.

6. The magnetic element according to claim 3, wherein a ring core having a frame shape is arranged to surround an outside of the magnetic element.
